(19) United States
(12) Patent Application Publication
(10) Pub. No.: US 2010/0264098 A1
(43) Pub. Date: Oct. 21, 2010

(54) CHITOSAN-COATED FIBERS TO SATISFY NSF50 TEST STANDARD FOR SPAS AND POOLS

(76) Inventor: Kartik POTUKUCHI, Hopkinsville, KY (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 12/427,239

(22) Filed: Apr. 21, 2009

(51) Int. Cl. E04H 4/12; B01D 39/16; C02F 1/00; B01D 29/07; B29C 67/24

(52) U.S. Cl. 210/805; 210/504; 210/493.1; 210/491; 264/137

(57) ABSTRACT

A fibrous filter media is provided for meeting NSF 50 requirements for water turbidity in pools, hot tubs and spas which includes a sheet of nonwoven fibers coated with chitosan, wherein the sheet may be pleated or present in a stacked layer configuration.

### FIELD

The present disclosure is related to the filtration and treatment of water in pools and spas, and more particularly, to the use of chitosan-coated fibers as a media which may satisfy the NSF50 test standard for turbidity reduction.

### BACKGROUND

Swimming pools, spas, whirlpools and hot tubs may be enjoyed and used to improve one's health as well as relieve physical and psychological stresses. Swimming pools, spas, whirlpools and hot tubs require that the water be filtered in order to assure that the water is kept clean in terms of water quality. The control of dirt, debris, hair, oils, and microorganisms from the water may be critical towards ensuring the health and safety of the individuals using such. This may be particularly true with indoor swimming pools which may generally be heated and used year round. Sweat, hair and other foreign matter originating from the human body may be sources of bacterial growth that may contaminate the water and deteriorate its quality.

To eliminate contaminants, the water has traditionally been treated by continuous passage through relatively fine filters containing sand or diatomaceous earth, following passage through a relatively coarse filter for the removal of materials such as particulates, dirt, debris, insects, hair, etc. The water may then be returned to the pool or tub. Generally, a chemical product such as chlorine, chlorine dioxide, bromine, iodine, ozone or the like, may be added to the water as it is being circulated in order to provide a safe environment for use.

Sand and diatomaceous earth have typically been the filtration media of choice, but are not the only filtration media currently available. Substitutes for sand and/or diatomaceous earth include ceramic filters and activated carbon. For example, porous ceramic filters have a three-dimensional network of extremely fine filtering spaces that can trap organic matter, such as oils. However, these ceramic filters can become easily clogged with the build-up of oils, dirt and biofilm formed by microorganisms associated with the typical pool environment. Most pool filter systems require occasional backwashing to rejuvenate the filter media. Many different types and styles of diatomaceous earth filters are available. Some are designed to be pressure backwashed Oils (body oils, tanning oils, etc.) typically float on the surface of the water. In pool and spa situations with high concentrations of oils, significant quantities of oil may simply flow through the filter and return to the vessel. The oils that are trapped by diatomaceous earth tend to bond the filter cake to the grids and eventually may impregnate the grid material itself. The end result may be large volumes of water needed to backwash the diatomaceous earth from the grids, fouled grids and an increasing buildup of diatomaceous earth at the bottom of the filter. Oils that are not removed may result in scum lines in the pool/spa and reduced water clarity.

Alternatively, the filter often used for the filtration of pool or spa water may be a filtration cartridge mounted in combination with the water delivery system. The coarsely filtered water may be filtered through a system comprising a basket or filter cartridge containing a filter bag or a filter element. Filter elements may generally be made of a pleated fabric arranged radially around a central cylinder. The base of the cartridge may be in communication with a suction system in order to filter the water that enters from the outside of the cartridge and passes through its walls. Although the fabric filter may remove contaminants, it may become soiled relatively quickly from the build up of oils, microorganisms and biofilm, and it may be quite difficult to clean due to its construction. Cleaning of the filter may not easily lend itself to decontamination and removal of microorganisms.

NSF International has been recognized as a leader in public health safety for pools and such. For the last 40 years, NSF has been helping people Swim Safer™ by meeting the needs of public health inspectors, product manufacturers, aquatic facility managers, facility users, and homeowners through a vast array of testing and certification services.

At the core of NSF's service offerings to this industry is the NSF Pool and Spa Equipment Program. This program encompasses voluntary standards, such as NSF/ANSI Standard 50, plus various standards criteria from ASTM, ASME, and others.

Of all the relevant pool and spa industry standards and criteria, NSF/ANSI Standard 50 is special due to the manner in which it was created and its continued evolution. The registered NSF Certification Mark on a pool, spa, or hot tub system component confirms that NSF has assessed—and certified—its conformity with the relevant section of NSF/ANSI Standard 50 and/or other product standards.

NSF/ANSI Standard 50—Equipment For Swimming Pools, Spas, Hot Tubs and Other Recreational Water Facilities works to enable a comprehensive product evaluation for health effects safety, performance validation, and safety for factors such as burst, sustained pressure, cyclic pressure, head loss, turbidity reduction, filtration efficacy, disinfection efficacy, durability or life testing, chemical resistance, corrosion resistance, and electrical safety.

NSF Standard 50 applies to diatomite and other pre-coat media filters, sand filters, cartridge filters, recessed automatic surface skimmers, centrifugal pumps, drains, flexible pool and spa hose, adjustable output rate chemical feeding equipment, multiport valves, flow-through chemical feeding equipment, and process equipment, including: in-line and brine type electrolytic chlorinators; copper/silver and copper ion generators; UV systems; and ozone generators. The components and materials are intended to be used specifically for swimming pool, spa, or hot tub water circulation and treatment in both public and residential applications.

Section 5.4, Cartridge-type and High-permeability-type Filters, references Section B.4, Filter Media Cleanability Test, which specifies the method to determine head loss through the filter after cleaning. It should not exceed 150% of the initial head loss and not exceed the design head loss. Section B.5, Turbidity Reduction Test, specifies the method to determine turbidity reduction. The turbidity remaining ratio (TR) shall be ≦0.3 or a 70% or greater reduction in turbidity after 5 passes of testing.

Accordingly, there is a need for fibrous filters that are relatively inexpensive and wherein the fibers are coated with a material that satisfies the requirements of NSF 50.

### SUMMARY

In a first aspect, the present disclosure is directed at a nonwoven filter media comprising a sheet of nonwoven fibers and chitosan, wherein the chitosan has been deposited on said nonwoven fibers at a level of 0.5% to 8.0% by weight wherein the filter indicates a turbidity remaining value (TR) of less than 0.3 after a fifth turnover of water volume when testing in accordance with NSF 50, Annex B.5.

In a second aspect, the present disclosure is directed at a method of producing a nonwoven filter comprising providing a sheet of nonwoven fibers, providing a solution of chitosan in water, and dispersing the solution onto the sheet. This may be followed by drying the sheet to evaporate said water and forming the sheet into a filter media. The chitosan may be present on said fibers at a level of 0.5% to 8.0% by weight wherein the filter indicates a turbidity remaining value (TR) of less than 0.3 after a fifth turnover of water volume when testing in accordance with NSF 50, Annex B.5.

In a third aspect, the present disclosure is directed at a method of treating pool and spa water, comprising providing a quantity of water to be filtered and providing a filter including filter media. This may then be followed by circulating the quantity of water through said filter media, wherein the filter media comprises nonwoven fibers and chitosan. The chitosan may be deposited on the nonwoven fibers at a level of 0.5% to 8.0% by weight and wherein the filter indicates a turbidity remaining value (TR) of less than 0.3 after a fifth turnover of water volume when testing in accordance with NSF 50, Annex B.5.

### BRIEF DESCRIPTION OF THE DRAWINGS

The above-mentioned and other features and advantages of this disclosure, and the manner of attaining them, will become more apparent and the disclosure will be better understood by reference to the following description of embodiments taken in conjunction with the accompanying drawings, wherein:

FIG. 1 is a prospective view of a filter element according to the present disclosure;

FIG. 2 is a graph indicating the Turbidity Remaining Ratio for treated and untreated fibrous filters after a number of successive tests according to NSF 50 Section B.5.

### DETAILED DESCRIPTION

Chitosan is a linear polysaccharide composed of randomly distributed β-(1-4)-linked D-glucosamine (decetylated unit) and N-acetyl-D-glucosamine (acetylated unit). It is a natural occurring substance (produced by the deacetylation of chitin, the structural element in the exoskeleton of crustaceans such as crabs and shrimp). Chitosan may be biodegradable and may have anti-microbial and anti-fungal properties.

Chitosan has been shown to improve flocculation and to cause fine sediment particles to bind together. Chitosan may also remove phosphorus, heavy minerals, and oils from water.

The present disclosure is directed at the use of chitosan to assist a nonwoven substrate to augment fluid filtration as applied to the pool and spa filtration market, and in particular, to replace the need to pre-load with a filter aid such as diatomaceous earth. This may be achieved without sacrificing the ability to achieve NSF 50 test standards.

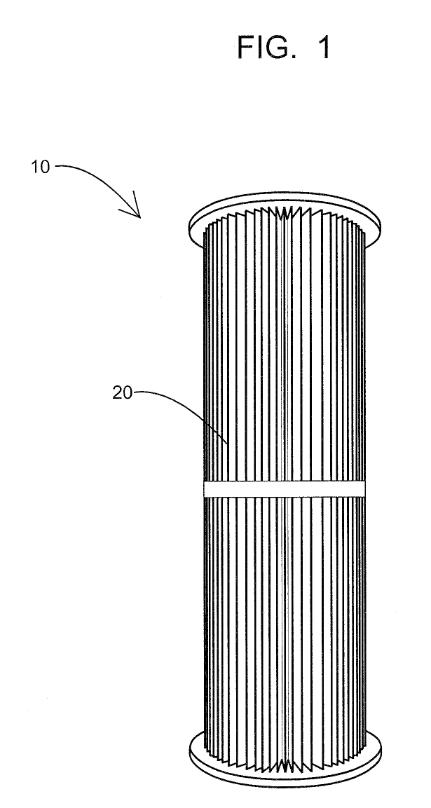

FIG. 1 is perspective view of a filter cartridge 10 having a pleated fabric media 20 made of non-woven fibers which have been coated with a solution containing chitosan, resulting in the deposition of about 2.0 to 4.0% by weight of chitosan to the fibrous media. Giving considerations to filtration requirements and production efficiency, the deposition of chitosan may therefore now be conveniently applied in the range of 0.5%-8.0% by weight for a given fibrous media, including all values therein, in 0.1% increments.

The fibers may be in the form of a nonwoven or carded nonwoven and may further comprise a web of spunbonded polyester bi-component core-sheath fibers. The sheath portion of the fiber may be bonded to one or more adjacent fibers, forming an interconnected array of fibers. The sheath material connects the fibers together, such that the nonwoven filter media may be porous. This bonding may generally be accomplished by melting the sheath material about the core fiber. At points of contact, the melted sheath material solidifies upon cooling, thereby forming an interconnected porous filter media. The fibers may have a denier in the range of about 2-6, preferably about 4.

The nonwoven fabric may be stacked in layers or pleated to form the filter media.

It is contemplated that the nonwoven fabric may be formed from meltblown fibers as well as spun bonded. As used herein, the term “nonwoven fabric” is used to mean a sheet that has a structure of individual fibers or filaments which are interlaid, but not in an identifiable repeating manner.

As used herein, the term “spunbonded” is understood to mean the process of producing a web or sheet of small diameter fibers and/or filaments which are formed by extruding a molten thermoplastic material as filaments from a plurality of fine, usually circular, capillaries in a spinneret with the diameter of the extruded filaments then being rapidly reduced, for example, by fluid-drawing or other well known spunbonding mechanisms.

As used herein, the term “meltblown” is understood to mean the process of producing fibers formed by extruding a molten thermoplastic material through a plurality of fine, usually circular, die capillaries as molten threads or filaments into a high-velocity gas (e.g. air) stream which attenuates the filaments of molten thermoplastic material to reduce their diameters, which may be to microfiber diameter. Thereafter, the meltblown fibers are carried by the high-velocity gas stream and are deposited on a collecting surface to form a web of randomly dispersed meltblown fibers.

While the description above regarding FIG. 1 mentions sheath-core bicomponent fibers, it is contemplated that other configurations of bicomponent fibers may be used, including but not limited to, side-by-side, segmented pie structure and islands-in-the-sea (matrix/fibril).

As used herein, the term “bicomponent fibers” is understood to mean fibers produced by extruding two polymers having different melting points from the same spinneret with both polymers contained within the same filament.

While the description above mentions polyester fibers being used, it is further contemplated that other materials may be used to form the bicomponent fibers, such as polyamide, polyolefin, polycarbonate, polystyrene, thermoplastic elastomer, fluoropolymer, vinyl polymer and combinations thereof.

The basis weight of the nonwoven fabric may generally range from about 70 to about 200 g/m², preferably from about 100 to about 150 g/m², and most preferably about 135 g/m². The nonwoven fabric may generally have a thickness range from about 0.4 to about 1.0 millimeters, preferably about 0.5 millimeters.

To coat the fibers with chitosan, as alluded to above, a solution of about 2.0% to 4.0% chitosan in water was prepared, the nonwoven fabric was run under a roll submerged in the solution to wet the it and then run through two rubber rolls to squeeze the excess solution out to achieve a level of about 2.0 to 4% by weight of chitosan on the fabric. After drying to remove the water, the fabric was formed into a single layer filter element about 3 inches in diameter and about 0.5 mm in thickness. The effective filter area was about 38.6 cm².

The filter element was inserted into a filter cartridge which was part of a recirculating system designed for testing turbidity according to NSF 50. The parameters of the test regimen were as follows:
Specified Water temperature, 24+6° C.
Specified Turbidity prior to adding silica, (TB1), ≦2 NTU*
Specified Turbidity after adding silica, (TB2), 45+10 NTU* *NTU is a measure of turbidity in Nephelometric Turbidity Units
Actual Flow rate, 0.16 liters per minute
Actual Water volume, 1.6 liters
Actual Water temperature, 20° C.
Turn-over time, 10 minutes
Testing material, Sil-Co-Sil® 106
Turbidimeter, HACH2100N

The filter element having chitosan-treated fibers, 135CNG, was tested and the results compared to a filter element having the same nonwoven construction but not treated with the chitosan solution, 135NG. The results of the turbidity test for each filter element, 135CNG and 135NG, are listed below in Table 1.

TABLE 1

| | | |
|---|---|---|
| 135CNG | | 135NG |
| (with chitosan) | | (without chitosan) |
| TB1 = 0.2 NTU | Turnover** | TB1 = 1.03 NTU |

| | | | | |
|---|---|---|---|---|
| TB2 | 46.7 | | TB2 | 45.7 |
| TB3 | 15.5 | 1 | TB3 | 32.3 |
| | 9.36 | 2 | | 26.0 |
| | 8.19 | 3 | | 22.4 |
| | 5.82 | 4 | | 20.3 |
| | 4.14 | 5 | | 17.6 |

**Turnover is the number of times that the water volume is passed through the filter.

To calculate the Turbidity Remaining (TR),

TR=(TB3−TB1)/(TB2−TB1)

wherein TR which must be less than 0.3, after the fifth turnover of the water volume.

Table 2 identifies the TR values for the individual turnovers for each filter element.

TABLE 2

| 135CNG (with chitosan) | | 135NG (without chitosan) |
|---|---|---|
| TR | Turnover | TR |
| 0.329 | 1 | 0.700 |
| 0.197 | 2 | 0.559 |
| 0.172 | 3 | 0.478 |
| 0.121 | 4 | 0.431 |
| 0.085 | 5 | 0.371 |

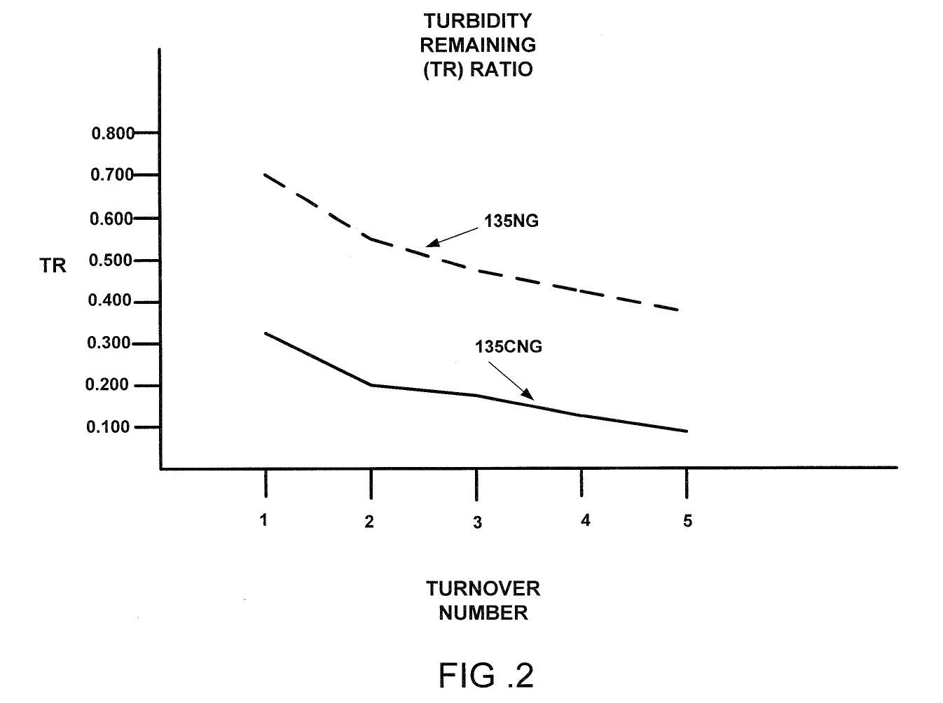

As can be seen from Table 2, the filter element containing chitosan (135CNG) met the required level of Turbidity Remaining (TR≦0.3) after the second through fifth turnover, while the untreated filter element (135NG) was unable to meet the requirement after any of the turnovers. FIG. 2 shows these results in graphical form.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A nonwoven filter media comprising:
a sheet of nonwoven fibers and chitosan, wherein the chitosan has been deposited on said nonwoven fibers at a level of 0.5% to 8.0% by weight wherein said filter indicates a turbidity remaining value (TR) of less than 0.3 after a fifth turnover of water volume when testing in accordance with NSF 50, Annex B.5.

2. The filter media of claim 1 wherein said sheet is pleated to form said filter media.

3. The filter media of claim 1 wherein said sheet is stacked to form said filter media.

4. The filter media of claim 1 wherein said chitosan level is in the range of about 2.0% to 4.0% by weight.

5. The filter media of claim 1 wherein said fibers comprise bicomponent polyester fibers in a sheath-core configuration.

6. The filter media of claim 1 wherein said sheet has a basis weight in the range of about 70 to about 200 g/m².

7. The filter media of claim 1 wherein said filter media provides a turbidity remaining ratio of ≦0.3 when tested to NSF 50, Annex B.5.

8. A method of producing a nonwoven filter comprising:
providing a sheet of nonwoven fibers;
providing a solution of chitosan in water;
dispersing said solution onto said sheet;
drying said sheet to evaporate said water;
forming said sheet into a filter media,
wherein said chitosan is present on said fibers at a level of 0.5% to 8.0% by weight wherein said filter indicates a turbidity remaining value (TR) of less than 0.3 after a fifth turnover of water volume when testing in accordance with NSF 50, Annex B.5.

9. The method of claim 8 wherein said sheet is pleated to form said filter media.

10. The method of claim 8 wherein said sheet is stacked to form said filter media.

11. The method of claim 8 wherein said chitosan level is in the range of about 2.0% to 4.0% by weight.

12. The method of claim 8 wherein said fibers comprise bicomponent polyester fibers in a sheath-core configuration.

13. The method of claim 8 wherein said sheet has a basis weight that is in the range of about 70 g/m² to about 200 g/m².

14. A method of treating pool and spa water, comprising:
providing a quantity of water to be filtered;
providing a filter including filter media;
circulating said quantity of water through said filter media,
wherein said filter media comprises nonwoven fibers and chitosan, wherein the chitosan has been deposited on said nonwoven fibers at a level of 0.5% to 8.0% by weight and wherein said filter indicates a turbidity remaining value (TR) of less than 0.3 after a fifth turnover of water volume when testing in accordance with NSF 50, Annex B.5.

15. The method of claim 14 wherein said filter media comprises a pleated sheet.

16. The method of claim 14 wherein said filter media comprises a sheet stacked in layers.

17. The method of claim 14 wherein said chitosan level is in the range of about 2.0% to 4.0% by weight.

18. The method of claim 14 wherein said fibers comprise bicomponent polyester fibers in a sheath-core configuration.
